(19) United States
(12) Patent Application Publication
(10) Pub. No.: US 2010/0076863 A1
(43) Pub. Date: Mar. 25, 2010

(54) HOSTING PLATFORM

(76) Inventor: Vitaly M. Golomb, San Francisco, CA (US)

Correspondence Address: Workman Nydegger;1000 Eagle Gate Tower, 60 East South Temple, Salt Lake City, UT, 84111, US

(21) Appl. No.: 12/235,191

(22) Filed: Sep. 22, 2008

(51) Int. Cl. G06F 17/30; G06Q 40/00; G06Q 30/00

(52) U.S. Cl. 705/27; 705/40; 705/26

(57) ABSTRACT

A hosting platform provides website hosting for customers. The hosting platform may be operated in a cloud hosting environment and may comprise an application signup and billing module, a content management system, a transaction module, and optionally a messaging system and/or end-customer management and authentication module. To enable website hosting in different industries, the content management system can provide access to modules adapted for a particular industry, such as print, music, or the like. The modules adapted for a particular industry allow customers in the particular industry to engage in the online sale of products or services with an order flow that can be adapted for the particular industry. Alternately or additionally, a consumer portal can be provided for each industry allowing end-users, e.g., end-customers, of a particular industry to connect peer-to-peer in relation to customers of the hosting platform that provide products or services within the particular industry.

### BACKGROUND OF THE INVENTION

1. The Field of the Invention

The present invention relates to web-hosting services and related technologies. More particularly, embodiments of the invention relate to hardware, software, systems, and methods for providing hosted services on behalf of one or more customers.

2. The Relevant Technology

The printing industry is one of the biggest manufacturing industries in the United States and the world. One segment of the printing industry, direct mail, has grown tremendously with the advent of variable data printing and digital production methods. Further, the rise of permission marketing has divided large drawn-out direct mail campaigns of the past into smaller-run and constantly changing mailers. This has driven tremendous success in the direct mail field as well as short- and medium-run printing.

Another segment of the printing industry, catalog printing and distribution, has also grown tremendously, although not in the same traditional form. In particular, in the past catalogs were used for mail order where readers receive the catalog, place an order for a desired product, and receive the product at a mailing address or local retailer via a postal service. Now catalogs are often used as large direct mail pieces which drive readers to a corresponding retail store or online to complete the actual purchase transaction.

Currently there is a massive consolidation in progress in the printing industry due to evolving technology and sales models. The traditional sales model in the printing industry relies heavily on the combination of technical capabilities (e.g., based on expensive capital equipment) and the relationships an account manager establishes with print buyers. According to this model, a customer of the printing entity often provides specifications for a print job or an entire campaign to the account manager who then provides an estimate (typically tabulated by a dedicated estimator) to the customer of the printing entity. In this case, it may take several hours, days, or longer before the estimate is ready for the customer. Additionally, the account manager and estimator may represent a significant overhead expense to the printer.

In certain situations, a customer may request an estimate or bid from multiple printers, even if the customer has a preference for a certain printer based on a relationship previously established by the account manager. This may be required for many large jobs and/or government projects by the corresponding company or government agency requesting the bid. In this case, the customer may have to identify and/or individually contact each of the multiple vendors, which may represent a significant burden to the customer in terms of both time and expense. Further, the relationship established by the account manager may have little or no effect on the customer if a competitor has submitted a more competitive bid.

Thus, the traditional sales model in the printing industry suffers from a number of disadvantages, including customer difficulty in obtaining print job estimates from printers, printer overhead expenses for estimators and/or account managers, and other disadvantages such as difficulty of order-submission. To address one or more of these disadvantages, several printers have entered the printing market using the web-to-print sales model, which enables printers to automate price quotes, receive payments, and receive digital files using a web-enabled storefront. Many of these printers are growing at tremendous rates without a single sales person or estimator.

Unfortunately, many small- and mid-sized printers are limited in their access to the software and server system solutions required to implement a web-to-print service offering to customers. For instance, most of the hardware and software required for web-to-print services remains prohibitively expensive. The IT personnel and/or training required to maintain and administer the web-to-print services may represent a considerable additional expense these printers are unable to support. As a result, many small- and mid-sized printers lacking web-to-print service offerings are losing market share to larger printers and national chains that can spread these expenses across a broader customer base.

The printing industry is only one of numerous industries where high entry barriers prohibit small- and/or mid-sized entities from establishing an effective and industry-specific presence on the Internet. Thus, the subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF THE INVENTION

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Embodiments of the invention relate to systems and methods for providing hosted website services for multiple entities (referred to herein as “customers”) within one or more industries or groups. Embodiments of the invention include a hosting platform configured to provide website hosting and that operates in a cloud hosting environment. The hosting platform can include an application signup and billing module configured to sign up customers for website hosting services provided by an application service provider (“ASP”) via the hosting platform, a content management system configured to allow each customer to customize the customer's hosted website, and a transaction module configured to enable electronic transaction processing capabilities for each customer.

Embodiments of the invention alternately or additionally include a hosted server application that can be implemented in hosting platforms according to the invention. The hosted server application can include one or more modules that are configured for a particular industry, such as the print industry. A hosted web-to-print server application, for instance, can include a dynamic website module configured to enable printers to customize hosted web-to-print websites, a merchant module configured to enable each printer to receive print orders from end-users and to process electronic payments from end-users for print orders through the hosted websites, and a product/service catalog configured to enable printers to provide online order estimate and file upload capabilities to end-users for different types of print orders through the hosted websites.

Embodiments of the invention may alternately or additionally include a method for hosting web-to-print websites that includes maintaining website design templates that can be selected and customized by a printer into a printer-specific website. The method can further include receiving input from printers customizing their printer-specific websites, hosting the printer-specific websites, and providing access to web-to-print features and functionality through the printer-specific websites to end-users

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates one embodiment of an example operating environment in which embodiments of a hosting platform and/or hosted web-to-print server application can be implemented;

FIG. 2 depicts one embodiment of a hosting platform;

FIG. 3 depicts one embodiment of a hosted web-to-print server application;

FIGS. 4A-4F depict example web pages a customer can navigate in customizing a hosted website; and

FIG. 5 is a flow chart showing an example method of providing hosted web-to-print services for a plurality of printers.

### DETAILED DESCRIPTION OF THE PREFERRED EMBODIMENTS

Embodiments of the invention relate to methods and systems for providing web hosting services for industries where an online presence with industry-specific transactional functions is desired. The industries include, but are not limited to, the printing industry, the music industry, the non-profit industry, and the like or any combination thereof. In one example, web-to-print services are hosted for a plurality of printers/printing entities, such as full service print houses, corner copy shops, and the like. In this example, printers can sign up for and configure hosted and customized storefront websites from which the printing entities can provide online order estimates to customers and receive and process print orders from customers, including receiving electronic payments and/or digital files.

More generally, embodiments of the invention allow a first plurality of entities to sign up for and configure hosted and customized storefront websites. The customized storefront websites allow a second plurality of entities to interact with the websites to, e.g., request estimates for goods or services, request goods or services, browse available goods or services, pay for goods or services, contact the first plurality of entities directly, upload files to the first plurality of entities, or the like or any combination thereof. Thus, the second plurality of entities may be customers of the first plurality of entities in some examples. However, to avoid confusion herein, the first plurality of entities that sign up for and configure hosted and customized websites will be referred to herein as customers (e.g., customers of the hosting service), and the second plurality of entities that interact with the customers' websites will be referred to herein as “end-users” and/or “end-customers”.

In embodiments of the invention, a hosting platform is provided in a computer network, such as the Internet, for hosting web services for customers in any of a variety of industries (e.g., printing, music, non-profit, etc.). For instance, a hosted web-to-print server application can be provided through the hosting platform in the computer network for hosting web-to-print services for a plurality of printers or other customers. A printer is one example of a customer of the hosting platform. The hosting platform and/or the hosted server application may include a plurality of modules for providing the features and functionalities described herein. For instance, a look and feel customization module can provide access to a plurality of website design templates that a customer can choose from and customize. Alternately or additionally, a merchant module can enable a customer to electronically receive orders and payments for goods and/or services, such as printing services/goods, from end-users and a product and/or service catalog can enable a customer to provide online estimate and file upload capabilities to end-users.

The hosted server application may be installed and run on one or more computer servers that can be included in the hosting platform. Additionally, the hosted server application may have access to one or more storage devices, such as hard disk, tape, optical media, and the like or any combination thereof, wherein customer- and/or end-user-specific information can be stored for later use in calculating online estimates, processing submitted orders, providing electronic payment to customers of the hosting service, and/or for other functionality as described in greater detail below. Customers and end-users can use client computer systems with standard web browsers to access and use the hosted server application and/or hosting platform, its features and functionalities, without installing additional specialized client software configured for this specific purpose. Alternately or additionally, a downloadable application may be provided for the customers, end-users, or both.

To practice the invention, the client, server, and storage devices may be any devices useful for providing the described functions, including well-known data processing and storage and communication devices and systems such as computer devices typically used as hosts in users systems with processing, memory, and input/output components, and server devices configured to maintain and then transmit digital data over a communications network. Data typically is communicated in digital format following standard communication and transfer protocols. The data storage resources are generally described as disk, optical, and tape devices that implement RAID and other storage techniques that may use SCSI and other I/O, data transfer, and storage protocols, but the invention is not intended to be limited to the example embodiments or to specific hardware and storage mechanisms as it is useful for nearly any web hosting and data storage arrangements.

### I. Operating Environment

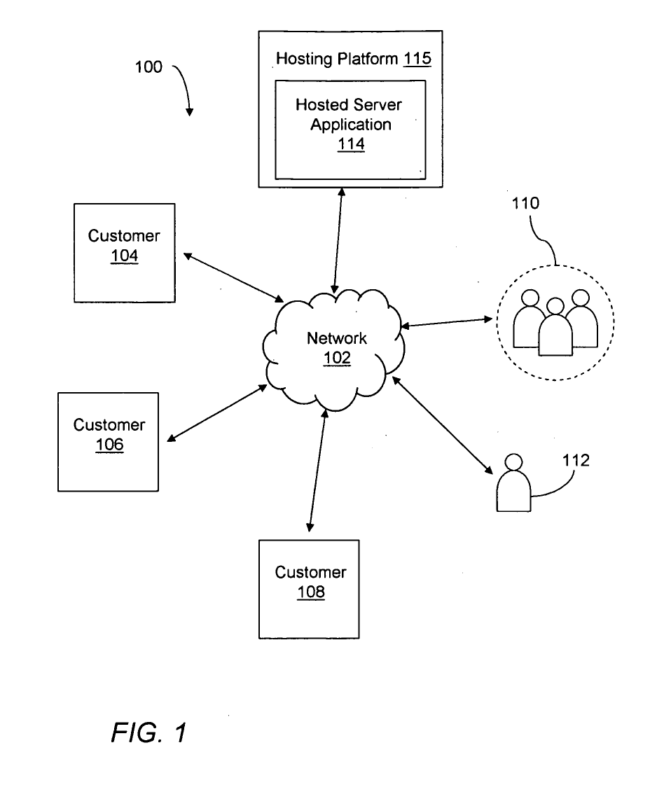

With reference now to FIG. 1, an example operating environment 100 is illustrated in which embodiments of the invention can be practiced. The example operating environment includes a computer network 102 over which customers 104, 106, 108 and end-users 110, 112 can communicate with and access the services provided by the hosted server application 114 operating on one or more computers servers of the hosting platform 115. The network 102 is illustrated in simplified form and may include the Internet which comprises a global internetwork formed by logical and physical connections between multiple wide area networks and local area networks. The network 102 may further include one or more wired and/or wireless networks such as, but not limited to, 802.xx networks, Bluetooth access points, wireless access points, IP-based networks, and the like.

The example operating environment 100 includes one or more customer entities 104-108 that may operate in or serve one or more vertical and/or horizontal segments of a particular industry or group. For instance, the customer entities 104-108 may comprise one or more printers, musicians, non-profit organizations, home owners association (“HOA”)/apartment managers, or the like or any combination thereof.

In one example described herein, the customer entities 104-108 include one or more printing entities that operate in or serve one or more vertical and/or horizontal segments of the printing industry. For instance, customer entity 104 may comprise a corner copy shop or other local printer with the equipment to provide short-run digital color and black and white services, as well as small scale bindery and/or other finishing services such as cutting, scoring, and/or laminating. Customer entity 106 may comprise a small single or duo color press owner specializing in inexpensive stationery printing (e.g., business cards, letterheads, envelopes, notepads, etc.). Customer entity 108 may comprise a larger entity with more expensive printing equipment, such as a sheet-fed offset press, web offset press, and/or large format printer. It will be appreciated by one of skill in the art that the printing entities and vertical/horizontal printing industry segments described herein are illustrative only and other printers/industry segments exist, such as printers that provide printing on promotional products and/or that manufacture and package optical media such as CDs and DVDs.

The operating environment 100 additionally includes one or more end-users or end-customers 110, 112 that may desire one or more products or services provided by the printers/customers 104, 106, 108. In the present example, the end-users 110, 112 may desire to obtain one or more printing products or services. End-user 112 comprises an individual end-user while end-user 110 comprises a company or other organizational end-user that may include a plurality of individual end-users.

Each of the printers 104, 106, 108 and end-users 110, 112 may have access to one or more client computer systems with web browsers that can be used to communicate with the hosted server application 114 over the computer network 102. The client computer systems may comprise, for instance, desktops, laptops, PDAs, smartphones, and the like or any combination thereof.

The hosting platform 115 is configured to allow customers 104, 106, 108 to sign up for and customize websites to be used as e-commerce storefronts where potential and existing end-users 110, 112 can view products and/or services offered by the customers, request online estimates, submit orders, upload files, electronically pay for products and services, and the like or any combination thereof. To this end, the hosting platform 115 may maintain a plurality of website design templates in local or remote storage that can be accessed by customers (e.g., through web browsers). Once a design template has been selected by a customer, it can be configured by the customer into a customized website that is hosted by the hosting platform 115. Thus, the hosting platform 115 can store the customer-specific customization information and hosts the customized websites.

In addition to customizing a corresponding website, each customer 104, 106, 108 can select specific features and/or functionality the customer wants to be made available for the customer's customized website. The different features and functionality provided by the hosting platform 115 and/or server application 114 may include one or more of: administration of text pages (e.g., about us, contact us, and/or other text pages) that are accessible through the customized website; electronic payment processing for credit card, eCheck, and/or wire transfer transactions; order history download for customers; encrypted storage of end-user payment information to facilitate online payments; designation of “open accounts” for receiving orders without requiring contemporaneous electronic payment; upload, edit, and creation of end-user templates by the end-users; upload, edit, and creation of templates by the customer for use by end-users; access control for end-users with multiple users (e.g., end-user 110); creation of online banners and coded text links for online campaigns; and tracking by customers and/or affiliates of online campaigns.

Alternately or additionally, the different features and functionality provided by the hosting platform 115 and/or server application 114 may include one or more of: access to one or more private-branded professional industry-standard templates, including printing templates, for instance; ability to create and store additional templates; end-user upload of files; providing online estimates for e.g., basic printing, stationery printing, sheet fed offset printing, web offset printing, large format printing, promotional products printing, optical media manufacturing and packaging, and/or finishing (e.g., cutting, scoring, binding, laminating); partial upload for large files and/or certain publications (e.g., that include a combination of new/versioned content and previously uploaded fixed content); virtual assembly of partially uploaded content and/or multiple independent files; online catalog of products, such as promotional products, offered by the customer 104, 106, or 108 and available for printing; and the like or any combination thereof.

In one embodiment, the hosting platform 115 and/or server application 114 is provided and administered by an ASP. The ASP may provide the hosting services described herein to customers free of charge and/or may collect fees for the services provided. In one embodiment the ASP may provide customers with a 30-day free trial period, after which continued service is provided for a fee. The ASP may charge fees on a periodic basis, on a use basis (e.g., per order), on a combination of periodic and use bases (e.g., nominal monthly fee plus overage charges for exceeding available storage capacity, order, and/or data transfer volume allowances), on a transaction basis (e.g., percentage of online transactions), and the like or any combination thereof.

In one embodiment, the hosted server application 114 can be accessed through a consumer portal where end-users can obtain information about customers of the ASP within a particular industry. For instance, end-users can search on the consumer portal for printers by their capabilities, locations, and the like. Alternately or additionally, end-users can compare pricing and turnaround from multiple printers, select a printer, and place an order with the selected printer. Alternately or additionally, end-users can use the consumer portal to read and/or post service reviews about particular printers.

While disclosed in the context of the printing industry, the hosting platform 115 can alternately or additionally be implemented to host a server application 114 adapted for “customers” in other industries, such as the music industry. For instance, a customer such as a musician might access the hosting platform 115 and/or hosted server application 114 through a web browser on a client computer to quickly customize a personalized musician website. The hosted server application 114 may allow musicians to upload audio, video, and/or picture files that can be viewed and/or purchased by their fans (e.g., the end-users). The hosted server application may also be able to process electronic transactions from end-users that wish to purchase music, merchandise, videos, ringtones, and the like from the musician. The hosted server application may also provide other functionality such as fan forums, musician calendar, mailing lists, band bios and blogs, reviews, and other functionality relevant to the music industry.

Alternately or additionally, the hosting platform 115 can host a server application 114 for “customers” in the non-profit sector, such as non-profit and charitable organizations. Similar to above, the non-profit organization can access the hosting platform 115 and/or hosted server application 114 to quickly and easily customize a professional-looking website, and/or to accept online donations, establish and manage online and other fundraising and/or awareness campaigns, post blogs and/or news updates, allow end-users to sign up for periodic email newsletters, and/or to access other functionality relevant to the non-profit sector.

Alternately or additionally, the hosting platform 115 can host a server application 114 for “customers” such as HOA or apartment managers. As with other customers, an HOA or apartment manager can access the hosting platform 115 and/or server application 114 to quickly and easily customize a professional-looking HOA or other community website that can be accessed by members of a particular HOA and/or community. The hosting platform 114 may allow the HOA/apartment manager and/or HOA board members to manage documents and projects online, receive amenity reservation or maintenance requests from residents, electronically collect dues from residents, email a periodic newsletter and/or announcements to residents, post announcements on a community home page, gather information from residents through electronic surveys, and the like or any combination thereof. The hosting platform 115 and/or hosted server application 114 may alternately or additionally allow residents to electronically submit amenity reservation or maintenance requests, access “community” documents (such as CCRs, community budgets, appliance manuals, or the like) online, share and view events on a community calendar, post and view community classifieds, participate in forums, access a local business directory, form groups (such as clubs and other special interest communities inside the community portal), share photos within the community, or the like or any combination thereof.

Alternately or additionally, the hosting platform 115 can host one or more other server applications for “customers” in one or more other industries not specifically identified herein to allow such customers to establish an online presence.

### II. Hosting Platform

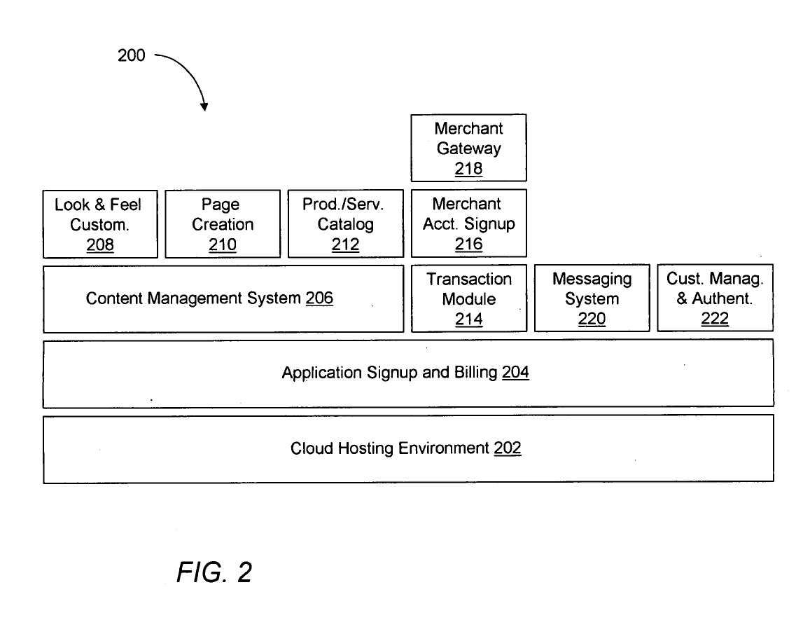

With additional reference to FIG. 2, one embodiment of a hosting platform 200 is depicted that may correspond to the hosting platform 115 of FIG. 1. As shown, the hosting platform 200 includes a number of modules and other components that can be implemented in software, hardware, or a combination of software and hardware, to provide the features and functionality described herein.

As disclosed in FIG. 2, the hosting platform 200 includes a hosting environment 202 and application signup and billing module 204. The hosting environment 202 can include a cloud hosting environment, also commonly referred to as cloud computing, a server cloud, or on-demand hosting. The hosting environment 202 can include many and/or all of the hardware resources necessary to operate one or more hosted server applications specific to one or more particular industries and is configured to dynamically allocate server capabilities to the hosted server applications running thereon depending on factors that may include demand, for instance. In some embodiments, the cloud hosting environment 202 can be administered and/or provided by a third party separate from the ASP.

The application signup and billing module 204 can be configured to collect and store certain information from customers when they sign up for services provided through the hosting platform 200. For instance, the module 204 can prompt a customer, through a web browser, to enter or provide certain information, such as a business name, phone number, billing address/city/state, contact person, and the like or any combination thereof, and then create an account for the customer. The module 204 can alternately or additionally be configured to prompt the customer to select a particular service plan and/or particular features/functionality that are provided through the platform 200. Further, the module 204 can be configured to track certain information associated with the customer for billing purposes, such as resource usage, number and/or dollar amount of transactions facilitated by the platform 200 within a given period and/or in aggregate, and the like or any combination thereof.

The hosting platform 200 additionally includes a content management system (“CMS”) module 206 that allows a customer to customize his/her hosted website. In some embodiments, the customer may obtain access to the CMS module 206 after completing a signup or enrollment process through the application signup and billing module 204. The CMS module 206 may control access to one or more other modules 208, 210, 212 configured for a particular industry (e.g., printing, music, etc.). For instance, the look and feel customization module 208 generally allows customers to select a particular website template from among one or more website templates and to customize the selected template. As another example, the product/service catalog module 212 generally allows customers to select one or more features/functionality and/or bundled services they wish to provide to end-users through their customized website. The available features/functionality and/or bundled services selectable by the customers can be configured by the ASP to be specific to particular industries. The page creation module 210 generally allows customers to create one or more static content web pages that can be accessed by end-users through the customer's customized website.

Transaction module 214 allows customers to sign up for an actual merchant account (as opposed to a visible third-party account such as a PayPal-style account). In some embodiments, the transaction module 214 allows a customer to begin processing electronic transactions with a new merchant account the same day the customer signs up for the new merchant account. This same-day processing ability may be facilitated through an Application Programming Interface (“API”)-level instant merchant account signup module 216 accessed through the transaction module 214. In some embodiments, the instant merchant account signup module 216 is completely integrated with the signup process of a particular merchant company with which the ASP of the platform 200 has a contractual agreement allowing same-day signup and transaction processing. The transaction module 214 further provides access to a merchant gateway 218 that allows customers to process electronic transactions with end-users, for instance. Alternately or additionally, the transaction module 214 may define the end-user order process that end-users go through when ordering products or services through a customer's customized website.

The hosting platform 200 additionally includes messaging system module 220 that can facilitate communication between the ASP and one or more customers, between one or more customers and one or more end-users, and the like or any combination thereof, via one or more means of communication, including, but not limited to, Email, SMS messaging, MMS messaging, RSS feeds, and the like or any combination thereof. For instance, the messaging module 220 may allow a customer (such as a printer) to send email and/or text message notifications to an end-user when a service (such as a print job) requested by the end-user has been completed or when a product ordered by the end-user has been shipped to the end-user, or the like. Alternately or additionally, customers and/or end-users may subscribe to a live status feed via the RSS or other protocol and view updates in an RSS reader of choice. Alternately or additionally, the application signup and billing module 204 may be configured to automatically send a notification through messaging system 220 (e.g., via Email, SMS, RSS) to a customer when the customer exceeds periodic usage under an applicable service plan. One skilled in the art will appreciate that the particular means of communication and usage scenarios described herein are merely illustrative of the different means and scenarios in which the message system module 220 can be implemented, and should not be construed to limit the invention.

As shown in FIG. 2, the hosting platform also includes an end-customer management and authentication module 222. The module 222 allows end-users to sign up for an end-user account (also referred to herein as an “end-user profile”), and may prompt an end-user for, and store, certain information particular to the end-user in the end-user account. For instance, the module 222 may collect billing information from an end-user such as billing address and a billing account number when the end-user requests services or goods from a first customer (or at any time that the end-user desires to setup an account). At a later time, the end-user can request services or goods from a different customer without having to enter billing information all over again, as this information may already be stored by the module 222. Alternately or additionally, the module 222 may collect contact information (e.g., email address, cell-phone address, physical address, or the like) from end-users that allows customers to communicate with the end-users. Thus, the module 222 enables end-users to set up a single account or profile that can be used by the end-user to interact with multiple customers of the platform 200.

The hosting platform 200 of FIG. 2 may correspond to the hosting platform 115 of FIG. 1. Similar to the hosting platform 115, the hosting platform 200 may provide the framework for hosting one or more hosted server applications, such as one or more hosted server applications adapted for the web-to-print industry, the music industry, the HOA industry, the non-profit industry, or the like or any combination thereof. Each hosted server application can include one or more of the components 202-222 included as part of the hosting platform 200. In some embodiments, for instance, an industry-specific hosted server application may include the modules 208-218. Furthermore, the modules 202-222 may be representative of and/or broken down into additional sub-modules.

### III. Hosted Server Application

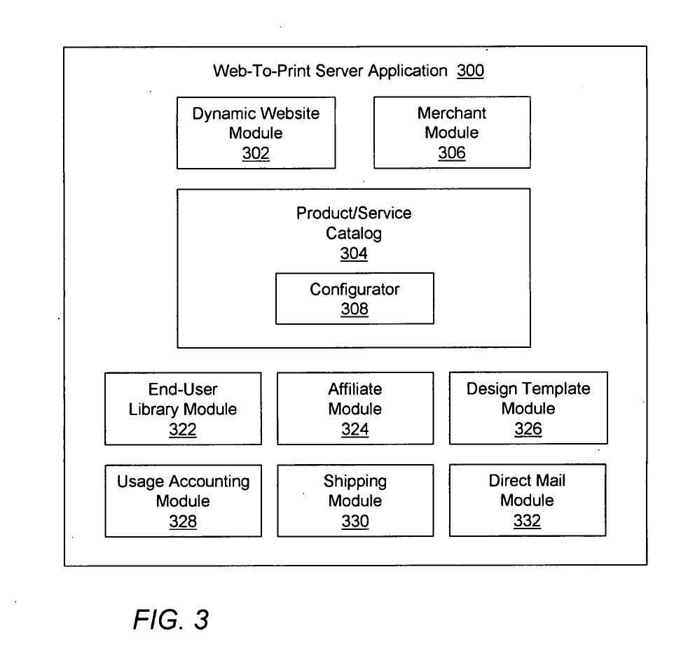

One embodiment of a hosted server application 300 adapted for the web-to-print industry is disclosed in FIG. 3. The hosted web-to-print server 300 may correspond to the hosted server application 114 of FIG. 1 and may include one or more of the modules disclosed in FIG. 2. As shown, the hosted server application 300 includes a number of modules and other components that can be implemented in software, hardware, or a combination of software and hardware, to provide the features and functionality described herein. Furthermore, not all of the modules and components described herein are required to practice the invention.

The hosted web-to-print server 300 includes a dynamic website module 302 having access to a plurality of website design templates that can be stored in storage (e.g., in an appropriate location of the server cloud 202 of FIG. 2). The dynamic website module 302 may be accessed through the CMS module 206 of FIG. 2, for instance, and may correspond to the modules 208, 210 of FIG. 2. During the process of a customer signing up for the services provided by the hosted server application 300, the dynamic website module 302 allows the customer to browse available website design templates and select a particular template for customization.

The dynamic website module 302 may enable the customer to enter customer-specific information, such as business name, business address, and so on, in one or more data fields of a webform that are then used to populate fields in a particular website design template, or to enter the customer-specific information directly into the template. Alternately or additionally, the customer may be able to upload one or more logos and/or other graphics for inclusion in the template and/or the customer may be able to select one or more colors and/or color schemes for the design template using the website module 302. The dynamic website module 302 may further provide the customer with the ability to administer one or more text pages (such as an “About Us” and/or “Contact Us” text page) that can be displayed upon selection of a corresponding link in the customer's customized website. The resulting customized website can then be maintained by the dynamic website module 302 in storage. Optionally, the customer can register a domain name to point to the customized website.

A merchant module 306 allows the customer to receive end-user orders and process electronic transactions such as credit card, eCheck, and wire transfers as payment for orders and defines the end-user order process. The merchant module 306 may include order history download functionality for synchronization with customer accounting systems and/or a fully featured online terminal to process automatic, manual, and/or refund orders. End-users may be given the option (e.g., through a customer management and authentication module 222) to store encrypted payment information (such as credit card numbers, bank account/routing numbers, and the like) on the server 300 (or platform 200 of FIG. 2), which the merchant module 306 can access for order payment.

The merchant module 306 may allow a customer to specify one or more “open accounts” which allow particular end-users to place orders without having to provide an approved method of payment. The merchant module 306 may allow end-users to designate an appropriate tax status (e.g., government agency, non-profit, resale, etc.) that may be relevant in the generation of electronic invoices by the merchant module 306. The electronic invoices can be viewed by the end-users and/or stored on the server 300 (or platform 200) in user accounts associated with the end-users. The merchant module 306 may correspond to the CMS module 206, and/or merchant gateway 218 of FIG. 2, for example.

A product/service catalog 304, which may correspond to the product/service catalog 212 of FIG. 2, allows the customer to provide online order estimates and/or file upload capabilities to end-users. The product/service catalog 304 can include a product configurator 308 adapted to provide online order estimates and/or file upload capabilities for virtually any printing type, including one or more of: basic printing, stationary printing, sheet fed offset printing, web offset printing, large format printing, promotional product printing, optical media printing and/or packaging, and the like or any combination thereof. Alternately or additionally, the product/service catalog 304 can include a plurality of different modules, each adapted for providing online order estimate and/or file upload capabilities for a particular printing type. Where the hosted server application 300 is adapted for an industry other than printing, the configurator module 308 can be configured to provide different industry-specific estimate, file upload, and/or other capabilities.

In addition to including modules for enabling customers to customize websites, enabling end-users to submit and pay for orders, and providing online estimates and file upload capabilities, the hosted server application 300 may optionally include one or more of: end-user library module 322, affiliate module 324, design template module 326, usage accounting module 328, shipping module 330, and/or direct mail module 332.

The end-user library module 322 provides online storage for end-users 110, 112 to be able to upload, edit and order commonly used collateral, such as business cards. Optionally, the end-user library module 322 may enable end-users to create editable templates and/or to specify one or more users that can have one or more levels of access to content uploaded/created by the end-user. For instance, the organizational end-user 110 of FIG. 1 may represent a company with multiple employees or users. One user may be able to upload/create content and then specify one or more additional users that can edit the content, access the content, and so on. This module may be further configured to generate print-ready files for the printer from content uploaded/created by the end-users 110, 112. The end-user library 322 may correspond to the customer management and authentication module 222 of FIG. 2.

Affiliate module 324 allows customers to create banners and coded text links for online advertising campaigns through affiliate websites. The affiliate module 324 allows the customers and/or their affiliates to advertise using the banners and coded text links and additionally tracks the online campaign (e.g., the number of banner or coded text link clicks). When implemented, the ASP may act as the trusted third party to administer payouts to the affiliates on behalf of the customers. The affiliate module 324 may be a printing or other industry-specific module accessible by a customer through a customer control panel or other login protected area.

Design template module 326 allows customers to create templates that can be stored and made available to end-users. For instance, most designers and office staff end-users are not trained in proper file setup for print. In order to make the order process easier and smoother, the customers can create templates for the end-users to conform their files to before submission. Design template module 326 may further have access to one or more private-branded professional industry-standard templates in storage that customers can select to make available to end-users. The design template module 326 may be a printing or other industry-specific module accessible through the CMS 206 of FIG. 2, similar to the modules 208-212, for instance. The templates that can be created, stored, and made available to end-users through design template module 326 should not be confused with the website design templates a customer can select in configuring a customized website.

Usage accounting module 328 performs a variety of processes related to tracking the use of the features and functionality provided by the web server application 300. For instance, usage accounting module 330 may track usage data for each customer, including the amount of data uploaded by end-users of the customer, the amount of storage occupied by the customer and/or end-users of the customer, the number of orders submitted to the customer, the number of clicks on banners and coded text links for customer online advertising campaigns, and the like or any combination thereof. The usage accounting module 330 can then export usage data to external billing and/or reporting systems. In some embodiments, the usage accounting module 328 may be included in the layer above the application signup and billing 204 of FIG. 2, exporting usage data to the module 204 for billing purposes.

Shipping module 330 may be included in or accessed through the transaction module 214 of FIG. 2. The shipping module 330 enables one or more shipping cost calculations to be made as part of the cost estimate capabilities provided through the product configurator 308 and/or as part of the transaction capabilities of the transaction module 214 of FIG. 2. The shipping module 330 may establish a direct connection (e.g., via the Internet or other network) to one or more shipping carriers (e.g., FedEx, UPS, USPS, or the like) to automatically calculate shipping cost for a particular order. The shipping module may alternately or additionally allow customers to submit shipments and/or produce shipping labels directly from the hosted server application 300. Alternately or additionally, the shipping module 330 may leverage the messaging system module 220 of FIG. 2 to automatically notify end-users of the shipping status of their orders.

Direct mail module 332 may be a printing or other industry-specific module accessible through the CMS 206 of FIG. 2, similar to the modules 208-212, for instance. The direct mail module 332 may permit end-customers to search and/or purchase mailing lists for direct mail campaigns supported by customers that have variable data printing and/or direct mail capabilities. A customer may have the option to activate the direct mail module 332 for certain products or services provided by the customer, such that an end-user sees a direct-mail-related step in the order process for the corresponding products or services which allows the end-user to search and/or purchase a mailing list. The mailing list can be attached directly with the order for processing during production by the printer of a particular print job. Revenue generated through the direct mail services provided by the module 332 can be shared, for instance, between a mailing list partner, the customer, and the ASP, although this is not required in all embodiments. In this manner, the customer gains the additional direct mail business with no additional effort on the customer's part.

It will be appreciated by those skilled in the art, with the benefit of the present disclosure, that the hosted server application 300 and the modules it includes are merely examples of a hosted server application that can be implemented on the hosting platform 200 of FIG. 2. The hosted server applications that can be implemented on the hosting platform 200 of FIG. 2 can be adapted for different industries and can have more or fewer modules and/or third-party plug-ins than those disclosed in FIG. 3 with similar or different functionality.

In some embodiments, the hosting platform 200 can be leveraged by third party developers to build and deploy their own industry-specific hosted server applications. For instance, the owner/ASP of the hosting platform 200 can provide one or more APIs and/or software development kits (“SDKs”) for use by third party developers that allow the third party developers to define an end-user order process and product/service catalog that are adapted for a particular industry. Thus, rather than creating their own hosting platform or hosted server application from scratch, a third party developer can simply modify the product/service catalog 212 or create a new product/service catalog that is specific to the industry of their choice and/or modify the transaction module 214 to adapt the end-user order process for the chosen industry. Alternately or additionally, third party developers can leverage the hosting platform 200 to create a consumer portal specific to the chosen industry.

Alternately or additionally, the owner/ASP of the hosting platform 200 can charge each third party developer one or more fees for allowing the third party developers to leverage the hosting platform 200. For instance the owner/ASP of the hosting platform can implement a revenue sharing agreement with each third party developer, or the like.

### IV. User Interface

In some embodiments, the user interface of the hosted server application 300 is designed consistent with web 2.0 best practices. This may include a clean, uncluttered AJAX enabled interface minimizing screen refreshes. The interface in this example may feel more like an application and less like a website to end-users and customers. As previously mentioned, and using the dynamic website module 302, customers may be able to choose from an array of pre-designed color and layout templates to match their particular branding. Alternately or additionally, customers may be able to customize website design templates for exact color matching (e.g., using CSS) and upload their own logos. Other elements such as RSS feeds can allow end-users to track orders, etc.

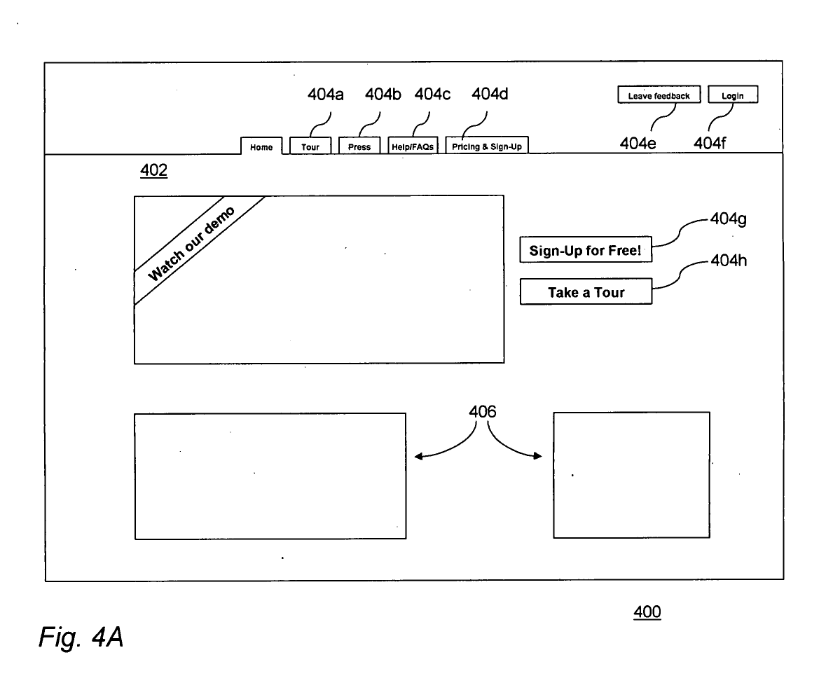

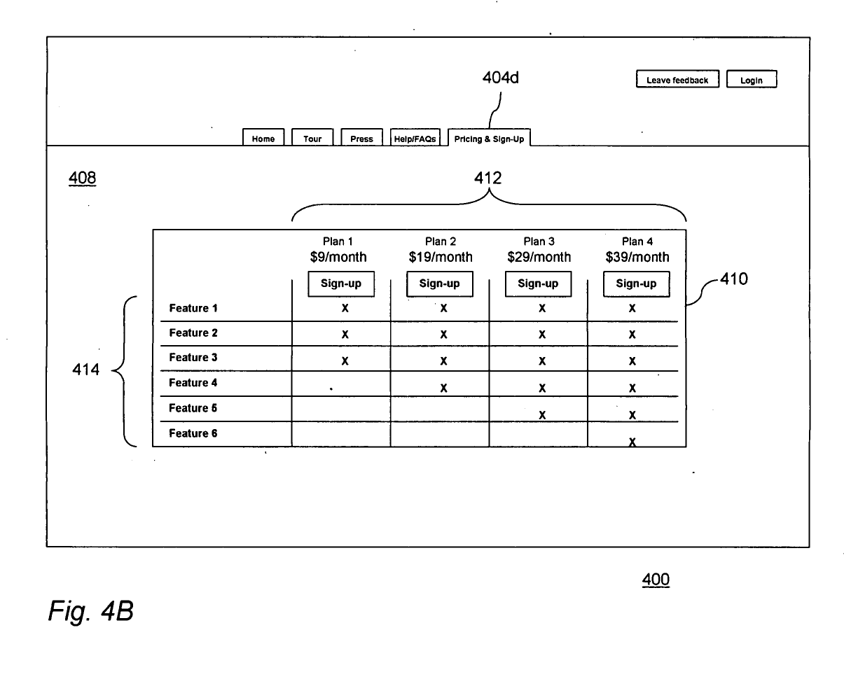

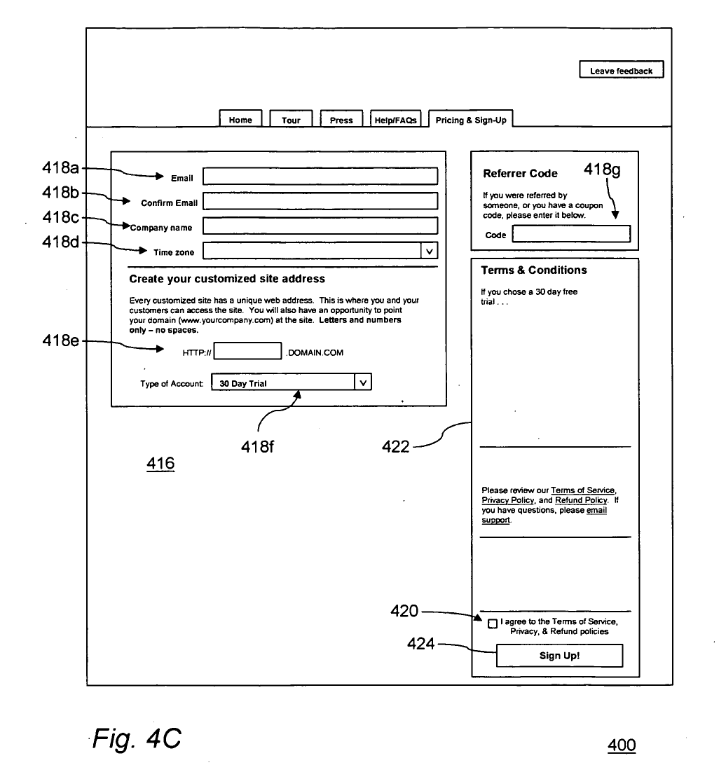

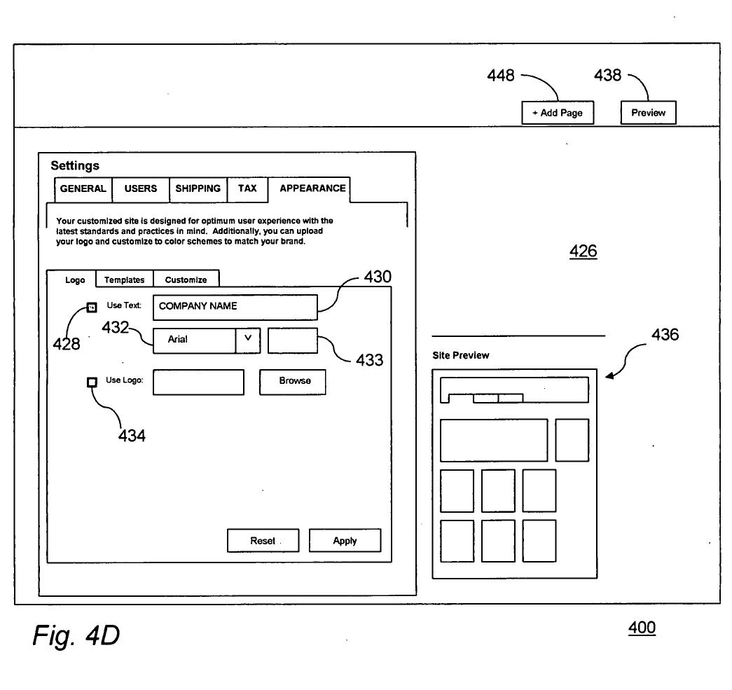

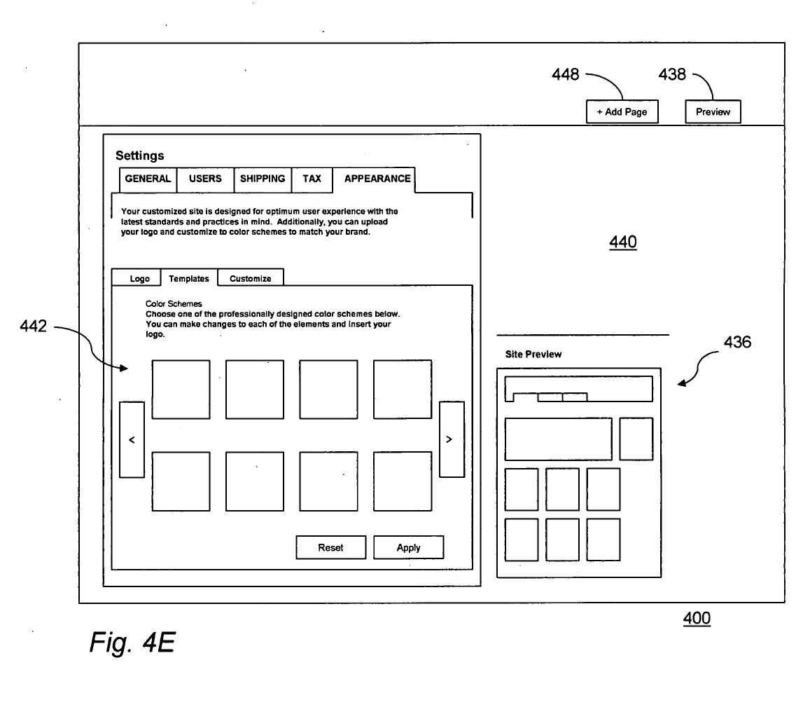

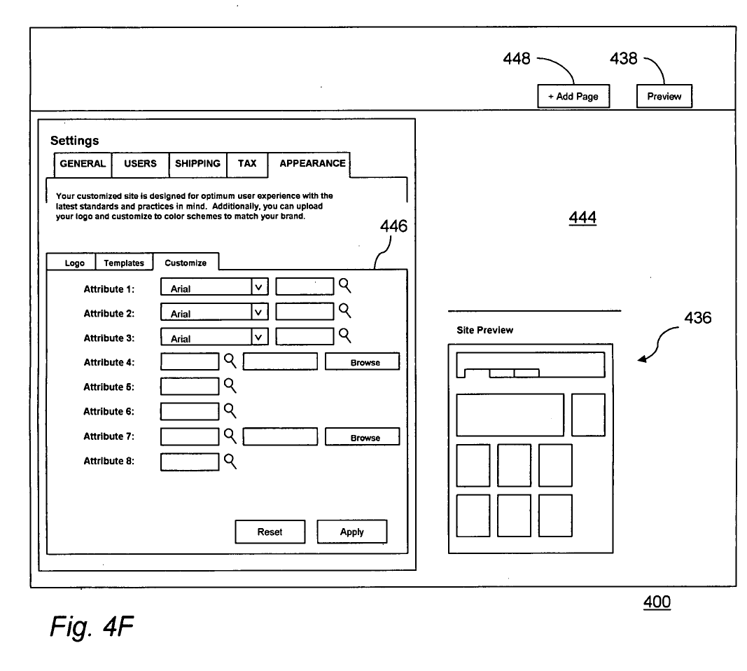

One example embodiment of a user interface 400 of the hosted server application 300 is disclosed in greater detail in FIGS. 4A-4F. For instance, FIG. 4A discloses an example embodiment of a “Home page” 402 that includes hyperlinks 404a-404h to other pages within the user interface 400. Optionally, the “home page” 402 can include one or more text areas 406 with a description of the website hosting services that a customer can obtain from the ASP administering the website 400 and/or including other information. It will be appreciated that the specific layout of the user interface 400 and the hyperlinks 404a-404h included in the home page 402 are merely examples and that other layouts and/or hyperlinks can be included in the user interface 400.

Each hyperlink 404a-404h may link to a different web-page within the user interface 400 and/or provide certain functionality. For instance, selection of the “Tour” hyperlink 404a (or 404h) may direct a potential customer or other user to a video (or other) online tour or presentation depicting the available features and functionality provided through subscription to the website hosting services provided by the ASP. The “Press” hyperlink 404b directs users to one or more press releases relating to the ASP. The “Help/FAQs” hyperlink 404c directs users to a help page that includes one or more frequently asked questions (“FAQs”) and corresponding answers relating to the website hosting services. The “Pricing & Sign-Up” hyperlink 404d links to a web page that can include pricing for different subscription levels, and the like. The “Leave Feedback” hyperlink 404e allows users to leave feedback. The “Login” hyperlink 404f allows existing customers to login to their profile to, e.g., make changes to their subscription level, to their customized website, or the like. The “Sign-Up for Free!” hyperlink 404g allows potential customers to sign up for a free customer account that may be limited in duration (e.g., 30 day free trial) and/or in functionality. Optionally, the hyperlink 404g may allow potential customers to sign up for a paid account that is not necessarily limited in time and/or functionality.

FIG. 4B discloses an example of a Pricing & Sign-Up web page 408 accessed by the hyperlink 404d. As shown, the page 408 includes a chart 410 displaying different available subscription plans—identified in FIG. 4B as Plan 1, Plan 2, etc.—and pricing 412 across the top-most row and different features and functionality 414 along the left-most column which are available in some or all of the subscription plans. Upon identifying a desired subscription plan, a potential customer can begin the sign-up process for the desired plan by selecting the “Sign up” hyperlink under the corresponding subscription plan. Other arrangements for displaying one or more different subscription plans and corresponding prices can alternately or additionally be implemented.

Upon selecting one of the “Sign up” hyperlinks near the top of the columns in the chart displayed on the web page 408 of FIG. 4B, the potential new customer can be directed to an example Sign-up form 416 disclosed in FIG. 4C, where the potential new customer is prompted to enter certain information in fields 418a-418g, each of which may be required and/or optional. The customer can enter and confirm an email address in fields 418a and 418b. In field 418c, the customer enters the name of their company. In field 418d, the customer can enter their time zone, which may be selected from a drop-down list in some embodiments. In field 418e, a customer can enter a domain name to point to their soon-to-be created customized website. Customers can select the type of account they desire to sign up for from a drop-down menu in field 418f, for example. Optionally, a new customer can enter a referrer code in field 418g that may provide the customer and/or the referrer with a discount or other incentive. Finally, a customer can check a box 420 to indicate agreement to the ASP's terms of service (which can be included in an area of the web page 416, such as in box 422), before selecting the “Sign Up!” hyperlink 424 to create their customer account/profile. In some embodiments, this stage of the sign-up process may be controlled by the application signup and billing module 204 of FIG. 2, for instance.

Once a customer has established an account profile, the customer can customize their website, as shown in FIGS. 4D-4F. In the example web page 426 illustrated in FIG. 4D, the customer can customize the appearance of their logo on the website. For instance, the customer can select box 428 to use text entered into information field 430 as their logo. The entered text may be, for instance, their company name, or DBA (e.g., “doing business as”) name. In this case, the customer can specify a particular font and/or color to use in displaying the text entered into field 430 by selecting the desired font from drop down menu 432 and entering a color identifier in field 433.

Alternately, the customer may be able to upload an image of their logo for display on their customized website by selecting box 434. Once the box 434 has been selected, the customer can then browse their computer to locate and upload their logo image.

FIG. 4D (as well as FIGS. 4E and 4F) further discloses that the web page 426 (and web pages 440, 444) can include a miniature site preview 436 of the customer's customized website. In some embodiments, the miniature site preview 436 can be updated in real time as the customer makes changes and modifications to settings. Optionally, the web page 426 can include a “Preview” hyperlink 438 that displays a full-size preview of the customer's website upon being selected.

As shown in the example web page 440 of FIG. 4E, in some embodiments the customer can customize their website by selecting a particular design template from amongst a plurality of design templates 442. Each of the design templates 442 can include different color schemes and/or different layouts.

As shown in the example web page 444 of FIG. 4F, in some embodiments the customer can customize their website by changing various settings displayed in customization box 446. Examples of the settings that can be changed include, but are not limited to, font and/or color of header text, font and/or color of body text, font and/or color of text hyperlinks, color of the customized website background, secondary color(s), page background color, header background color, button color, and the like or any combination thereof.

Once the customer has finished selecting the customizable elements (e.g., design template, font, color scheme, logo, etc.) and/or accepted various default settings, the hosted server application 300 allows end-users to access the customer's customized website and various features and functionality through a computer network such as the Internet. The customer's customized website can include one or more automatically generated or default web pages, such as a “home” page that includes one or more hyperlinks to other default web pages, such as an online estimate page, a payment page, a file upload page, a status page, and the like or any combination thereof.

In some embodiments, pricing information is provided by the customer during account setup or any time thereafter for use by the hosted server application 300 in performing online estimates. Alternately or additionally, the customer can establish a merchant account through the hosting platform 200 or independently, which merchant account can be used by the hosted server application 300 in processing electronic payments. The file upload capabilities available to end-users through the customer's customized website can depend, for example, on the subscription plan selected by the customer during account setup.

Optionally, the customer's customized website can include one or more web pages added by the customer and/or that include text administered by the customer. For instance, in some embodiments the customer may select the “+Add Page” hyperlink 448 disclosed in FIGS. 4D-4F to create various text pages within the customized website, such as an “About us” page, a “Contact us” page, and the like or any combination thereof.

According to embodiments of the invention, access to the customizable elements of the customer's hosted website can be controlled by the content management system 206 of the hosting platform 200 of FIG. 2. Alternately or additionally, one or more of the customized elements (e.g., color, font, logo, etc.) can be maintained across all web pages (e.g., home, about, file upload, online quote estimate, and other web pages) within the customer's customized website for consistent branding. For instance, the color scheme selected by the customer can be maintained across all web pages within the customer's website, along with placement of the customer's logo on every web page.

As disclosed herein, the account setup and customization processes for creating a customized, hosted website, can be linearized (e.g., in the manner of a setup wizard, for example) to guide new customers step-by-step such that even the least technologically savvy can easily setup an account profile and thereby establish an online presence. Moreover, in some embodiments of the invention, the account setup and customization process allows customers to setup an account profile and customized website in a matter of minutes, although more time can be taken if desired.

In some embodiments, each new customer can create a catalog of products and/or services offered by the customer to end-users. The creation of the customer's catalog can occur during account setup and customization and/or at any time thereafter. The customer catalogs allow end-users to browse each customer's available products and/or services and instantly select a desired product or service online.

Once the account setup and customization process is completed, the customized website can be accessed online immediately in some embodiments. In this manner, the customer can begin interacting online with end-users. For instance, end-users can access the customized website and online catalog to submit an online order.

In some embodiments, upon selecting a particular product or service from a customer's online catalog, an end-user can configure one or more attributes of the selected product or service. For instance, a customer's online catalog could include services such as basic printing, stationery printing, sheet fed offset printing, web offset printing, large format printing, promotional products printing, optical media manufacturing and packaging, and the like or any combination thereof. If an end-user were to select basic printing from the online catalog, the end-user might be able to configure the number of copies desired, ink color, finishing aspects, or the like. Alternately or additionally, if an end-user were to select stationery printing, the end-user might be able to configure the type of stationery (e.g., business cards, envelopes, letterhead, etc.), the amount of stationery desired, ink color, or the like. The selection of other services or products from the customer's online catalog can similarly allow the end-user to configure one or more attributes of the selected service or product.

According to some embodiments of the invention, as the end-user is configuring one or more attributes of a selected service or product, the hosted server 300 provides an online cost estimate for the requested service or product to the end-user through the customized website. The online cost estimate can be calculated in real-time as the end-user configures the various attributes of the selected service or product. Alternately or additionally, an end-user can configure the various attributes and select a “request quote” or other hyperlink of equivalent functionality before receiving an online cost estimate. In either case, the online cost estimate can be calculated by, e.g., the product configurator 308 of FIG. 3 using pricing information provided previously by the customer during creation of the customer's online catalog.

After one or more attributes of a selected service or product have been configured by an end-user as desired, the end-user can submit (e.g., by selecting an appropriate hyperlink) an online order for the selected service or product. Submission of the online order can be followed by or include a check-out process with subsequent account creation, payment, and/or file upload by the end-user. Alternately or additionally, the end-user may have a pre-existing end-user account profile that already includes encrypted payment information. The number, size and/or format of files that can be uploaded by the end-user can depend in some cases on the subscription plan (or particular features and functionalities) selected by the customer.

Optionally, the hosting platform 200 of FIG. 2 can host one or more consumer portal websites in addition to one or more customized consumer websites. In some embodiments, the consumer portal website can be accessed by end-users to search for and compare customers. The consumer portal website may include a search option allowing end-users to input certain search criteria such as location, capabilities, and the like and then view search results of customers satisfying the search criteria. The consumer portal website may alternately or additionally include a compare feature enabling end-users to select one or more customers for side-by-side comparison of pricing, capabilities, turnaround times, and the like or any combination thereof. The consumer website may alternately or additionally provide access to end-user created reviews of customers and allow end-users to write reviews of particular customers. Alternately or additionally, the consumer portal website may allow customers and/or end-users to post projects and request bids for the projects from other customers.

### V. Providing Hosted Web-to-Print Services

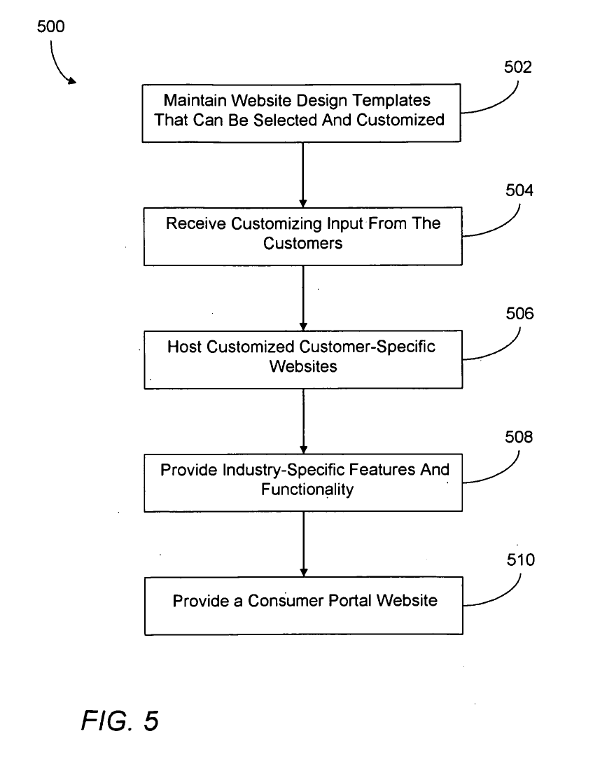

Turning now to FIG. 5, one embodiment of a method for providing hosted services is illustrated at 500, which may be implemented by the hosting platform 115 or 200 of FIG. 1 or 2. The method 500 can begin by maintaining 502 a plurality of website design templates that can be selected and customized by customers into customer-specific customized websites. For instance, the website design templates can be selected and customized by printers or other customers.

The customers can view the website design templates via a computer network and provide customization input, which is received 504 by the hosting platform 200. Customization input may include customer-specific information such as business name, business address, information for “About Us”, “Contact Us”, “Services” and/or other web pages within customized websites, uploaded business logos and/or other graphics, customer-specific pricing information for use in calculating cost estimates, customer-specific product and/or service catalogs, selection of one or more colors or color schemes of the customized website, and the like or any combination thereof. Customization input can alternately or additionally include the selection of one or more features and functionality selected individually and/or bundled into one or more subscription plans.

After receiving input from the customers, the hosting platform 200 hosts 506 a plurality of customer-specific websites via a hosted server application, such as the hosted web-to-print server application 300 of FIG. 3, using the customization input received from the plurality of customers that provided the input. In one embodiment, each customer-specific website can go live almost immediately after receiving some or all of the customer's customizing input. In some embodiments, a customer may be able to sign up for a customized website and have it go live in minutes. The hosted customer-specific websites can be accessed by end-users. Additionally, one or more aspects of each of the customer-specific websites can be administered by the corresponding customer to allow the customer to make changes to the website.

The method 500 further includes providing 508 a plurality of industry-specific features and functionality that are accessible on each of the plurality of customer-specific websites for end-users. For example, the features and functionality accessible on each of a plurality of customer-specific websites for end-users can include the ability for end-users to request and receive online cost estimates for print orders, the ability for end-users to submit print orders, and the ability for end-users to provide electronic payment for submitted print orders. The features and functionality accessible on or through one customer-specific website may differ from the features and functionality accessible on or through a different customer-specific website according to the configuration of the customer-specific websites by the corresponding customers.

Optionally, the method 500 may additionally include providing 510 a consumer portal website. The consumer portal website may enable end-users to search for customers based on one or more of customer capabilities, customer locations, and other criteria relating to information provided by the customers during customization of their corresponding websites. The consumer portal website may also enable end-users to compare pricing, turnaround times, and other information from a plurality of customers, and to select a particular customer, submit an online order to the selected customer, and provide electronic payment to the customer for the online order. The consumer portal website may also enable end-users to read and/or write product and/or service reviews for customers. Alternately or additionally, the consumer portal website may allow customers and/or end-users to post projects and request bids for the projects from other customers.

It will be appreciated by those skilled in the art, with the benefit of the present disclosure, that the method 500 is an example only and should not be construed to limit the invention. For instance, the method 500 may have more or fewer steps than those illustrated. As one example, the method 500 may omit the step 510 of providing a consumer portal website and/or include a step of charging one or more customers one or more fees based on the industry-specific online services provided on behalf of the one or more customers, and so on.

The embodiments described herein may include the use of a special purpose or general-purpose computer including various computer hardware or software modules, as discussed in greater detail below.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired and wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system and methods described herein are preferably implemented in software, implementations in hardware or a combination of software and hardware are also possible and contemplated. In this description, a “computing entity” may be any computing system as previously defined herein, or any module or combination of modulates running on a computing system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A hosting platform operating in a cloud hosting environment and configured to host a plurality of customized websites, the hosting platform comprising:
an application signup and billing module configured to collect information over a computer network from each of a plurality of customers when the customers sign up for websites hosted on the hosting platform;
a content management system configured to allow each customer to customize a corresponding hosted website after signing up through the application signup and billing module for the corresponding hosted website, each customer offering one or more products or services for sale through the corresponding hosted website; and
a transaction module configured to allow customers to electronically process payments from end-users for products or services purchased by the end-users from the customers via the corresponding hosted websites.

2. The hosting platform of claim 1, further comprising a messaging system module configured to facilitate communication between two or more of: a hosting entity that operates the hosting platform, one or more customers, and one or more end-users.

3. The hosting platform of claim 1, further comprising an end-customer management and authentication module configured to allow each end-user to setup an end-user account that allows each end-user to interact with multiple customers without creating a separate account for each customer.

4. The hosting platform of claim 1, further comprising a plurality of modules accessed through the content management system, the plurality of modules including:
a look and feel customization module configured to allow each customer to select and customize a particular website design template for the customer's hosted website;
a page creation module configured to allow each customer to create one or more web pages of static content that can be accessed through the customer's hosted website; and
a product/service catalog module configured to allow each customer to provide online cost estimates and file upload capabilities to end-users through the customer's hosted website.

5. The hosting platform of claim 4, wherein the plurality of modules accessed through the content management system are adapted for the printing industry to allow printers to sign up as customers of the hosting platform for hosted web-to-print websites.

6. The hosting platform of claim 4, wherein the application signup and billing module, content management system, transaction module, look and feel customization module, and page creation module are made accessible by an owner of the hosting platform to a software developer through an application programming interface, the application programming interface allowing the software developer to create and provide the product/service catalog module for access by customers.

7. The hosting platform of claim 6, wherein the owner of the hosting platform charges the software developer a fee for accessing the application signup and billing module, content management system, transaction module, look and feel customization module, and page creation module.

8. The hosting platform of claim 1, further comprising a plurality of modules accessed through the transaction module, the plurality of modules including:
an API level instant merchant account signup module configured to allow each customer to sign up for a merchant account and begin processing electronic transactions the same day; and
a merchant gateway configured to process electronic transactions for each of the customers.

9. The hosting platform of claim 8, wherein a hosting entity that operates the hosting platform charges each customer a fee for hosting the customer's hosted website.

10. The hosting platform of claim 8, wherein the API level instant merchant account signup module is integrated with the signup process of a merchant account provider, the integration enabling each customer to sign up for a merchant account and begin processing electronic transactions the same day.

11. A method of hosting websites for a plurality of customers, the method comprising:
maintaining a plurality of website design templates that can be selected and customized by customers into customer-specific websites;
receiving input from at least two customers customizing at least two customer-specific websites, including at least a first customer customizing a first website design template into a first customer-specific website and a second customer customizing a second website design template into a second customer-specific website;
hosting the at least two customer-specific websites;
providing access to a plurality of features and functionality through each of the at least two customer-specific websites, the plurality of features and functionality including the ability for an end-user to: receive an online order estimate from a corresponding customer for an online order, submit an online order to a corresponding customer, and provide electronic payment for an online order to a corresponding customer.

12. The method of claim 11, further comprising, charging each of the at least two customers one or more fees for services provided on behalf of each of the at least two customers, the one or more fees being based on one or more of: a time period during which services are provided on behalf of the corresponding customer; a usage amount of services provided on behalf of the corresponding customer; and a percentage of transactions completed on behalf of the corresponding customer.

13. The method of claim 11, wherein the plurality of features and functionality that are accessible on the first customer-specific website are different than the plurality of features and functionality that are accessible on the second customer-specific website, the features and functionality of each customer-specific website having been selected by the corresponding customer.

14. The method of claim 11, wherein the plurality of features and functionality additionally include one or more of: administration by a corresponding customer of text pages accessible through the corresponding customer-specific website; designation by one or more of the at least two customers of one or more open accounts that allow end-users to submit online orders to the one or more of the at least two customers without providing electronic payment at the same time; ability of one or more of the at least two customers to download an order history indicative of orders submitted to the one or more of the at least two customers; encrypted storage of end-user payment information to facilitate electronic payment by end-users; upload, edit, and creation of printing templates by end-users; upload, edit, and creation of printing templates by one or more of the at least two customers; creation by one or more of the at least two customers of online banners and coded text links for online advertising campaigns; tracking by one or more of the at least two customers of the online advertising campaigns; access to one or more industry-standard printing templates; ability of end-users to upload large files a piece at a time; virtual assembly of large files uploaded a piece at a time; and an online catalog of products, services, or both, offered by the customer.

15. The method of claim 11, further comprising, providing a consumer portal website that enables end-users to perform one or more of:
electronic searches for customers based on capabilities of the at least two customers, locations of the at least two customers, or both;
comparisons of pricing, turnaround times, or both, for two or more of the at least two customers; and
submission and electronic payment of an online order to one of the at least two customers.

16. The method of claim 11, wherein the input received from each of the at least two customers includes, for each of the at least two customers, one or more of: a business name of the customer; an image of a logo of the customer; an address of the customer; selection of the plurality of features and functionality; selection of one or more colors or color schemes for the corresponding customer-specific website; pricing information for calculating online estimates for end-users; a catalog of products, services, or both, offered by the customer; text for one or more web pages within the corresponding customer-specific website, including one or more of an “about us”, “contact us”, or “services” web page.

17. A hosted web-to-print server application, comprising:
a dynamic website module configured to enable a plurality of printers to customize hosted web-to-print websites with printer-specific information provided by the plurality of printers via a computer network, wherein the resulting plurality of customized web-to-print websites can be accessed by one or more end-users via the computer network;
a merchant module configured to enable each printer to receive print orders from end-users and to process electronic payments from end-users for print orders through the printer's customized web-to-print website; and
a product/service catalog configured to enable each printer to provide online order estimate and file upload capabilities to end-users for print orders through the printer's customized web-to-print website.

18. The hosted web-to-print server application of claim 17, wherein the online estimate and file upload capabilities provided through the printers' customized web-to-print websites depends on a subscription plan selected by each of the printers.

19. The application of claim 17, further comprising one or more of:
an end-user library module configured to allow end-users to upload, edit, and order collateral;
an affiliate module configured to enable printers to create banners and coded text links for online advertising campaigns through affiliate websites, wherein the affiliate module is further configured to enable printers and affiliates to track online advertising campaigns and to enable affiliates to receive payouts for online advertising campaigns;
a design template module configured to enable printers to create printing templates, wherein the design template module additionally has access to one or more industry-standard printing templates that printers can select to make available to end-users;
a usage accounting module configured to track one or more of: the amount of data uploaded by end-users in print orders for each printer; the amount of storage occupied by data of each printer, data of end-users submitted in one or more print orders for each printer, or both; the number of print orders submitted to each printer; website traffic for each printer's customized web-to-print website; and sales statistics for transactions facilitated through each printer's customized web-to-print website;
a shipping module configured to enable shipping cost calculations to be made as part of online order estimates; and
a direct mail module configured to enable end-users to search for, purchase, or both, mailing lists for direct mail campaigns supported by printers having variable data printing and direct mail capabilities.

20. The hosted web-to-print server application of claim 17, wherein printers and end-users communicate with the hosted web-to-print server application through web browsers on client computers of the printers and end-users.
